(19) United States
(12) Patent Application Publication
(10) Pub. No.: US 2021/0284135 A1
(43) Pub. Date: Sep. 16, 2021

(54) VEHICLE AND CONTROL DEVICE OF THE SAME

(71) Applicant: HONDA MOTOR CO., LTD., Tokyo (JP)

(72) Inventors: Satoshi Koike, Wako-shi (JP); Ryuichi Hata, Wako-shi (JP); Naoyuki Kubo, Wako-shi (JP); Takayuki Sakata, Wako-shi (JP); Masayasu Yoshida, Wako-shi (JP); Mitsuru Nonaka, Tokyo (JP); Seiichi Kato, Tokyo (JP); Masanori Yoshihira, Wako-shi (JP)

(73) Assignee: HONDA MOTOR CO., LTD., Tokyo (JP)

(21) Appl. No.: 17/171,144

(22) Filed: Feb. 9, 2021

(30) Foreign Application Priority Data
Mar. 11, 2020 (JP) 2020-042075

(51) Int. Cl. B60W 30/06; B60W 60/00; G06K 9/00

(52) U.S. Cl. CPC B60W 30/06; B60W 60/0025; G06K 9/00825; B60W 2556/65; B60W 2756/10; B60W 2420/42; B60W 2554/4041; G06K 9/00812

(57) ABSTRACT

A control device of a vehicle is provided. The device executes a following operation of controlling travelling of the vehicle such that the vehicle follows another vehicle based on information received from the other vehicle and a parking operation of controlling travelling of the vehicle to park the vehicle at a parking space, determines whether the vehicle is at a position at which the parking operation can be started; and notifies the other vehicle that leading can be finished, in a case where it is determined that the vehicle is at a position at which the parking operation can be started while the device is executing the following operation.

### CROSS-REFERENCE TO RELATED APPLICATION(S)

This application claims priority to and the benefit of Japanese Patent Application No. 2020-042075 filed on Mar. 11, 2020, the entire disclosure of which is incorporated herein by reference.

### BACKGROUND OF THE INVENTION

### Field of the Invention

The present invention relates to a vehicle and a control device of the vehicle.

### Description of the Related Art

Technologies for electronically coupling a following vehicle to a preceding vehicle so that the following vehicle automatically follows the preceding vehicle are known. In Japanese Patent Laid-Open No. 2019-1227, the following vehicle is controlled to keep a closest proximity distance to the preceding vehicle at a preset distance. In Japanese Patent Laid-Open No. 2019-156197, a movement state of the preceding vehicle is restricted based on the performance of the following vehicle. Also, a technology for automatically parking a vehicle without a need for an operation made by a driver has been provided (Japanese Patent Laid-Open No. 2019-25549). When the preceding vehicle finishes leading the following vehicle, the following vehicle needs to be moved to a position at which the following vehicle does not hinder traffic. It is possible to consider using an automated parking function of the following vehicle to move the following vehicle to such a position. However, the preceding vehicle does not know details of the automated parking function of the following vehicle, and accordingly does not know to which position the following vehicle needs to be led. Also, when the preceding vehicle starts to lead a following vehicle that is parked, the preceding vehicle does not know at which position the preceding vehicle needs to wait for the following vehicle.

### SUMMARY OF THE INVENTION

One aspect of the present invention makes transition from following to automated parking or transition from automated starting to following smooth. According to an embodiment, a control device of a vehicle is provided. The device includes a memory for storing computer readable code and a processor operatively coupled to the memory. The processor is configured to execute a following operation of controlling travelling of the vehicle such that the vehicle follows another vehicle based on information received from the other vehicle and a parking operation of controlling travelling of the vehicle to park the vehicle at a parking space, determine whether the vehicle is at a position at which the parking operation can be started, and notify the other vehicle that leading can be finished, in a case where it is determined that the vehicle is at a position at which the parking operation can be started while the travel control circuit is executing the following operation.

### BRIEF DESCRIPTION OF THE DRAWINGS

FIG. 1 is a block diagram showing an example configuration of a vehicle according to various embodiments.

FIG. 2 is a block diagram showing an example configuration of an electronically coupled travelling system according to various embodiments.

FIG. 3 is a schematic diagram for describing an example operation that is performed when finishing following according to a first embodiment.

FIG. 4 is a flowchart showing an example operation of a control device of a following vehicle according to the first embodiment.

FIG. 5 is a schematic diagram for describing an example operation that is performed when finishing following according to a second embodiment.

FIG. 6 is a schematic diagram showing a notification method according to the second embodiment.

FIG. 7 is a flowchart showing an example operation of a control device of a following vehicle according to the second embodiment.

FIG. 8 is a schematic diagram for describing an example operation that is performed when starting following according to a third embodiment.

FIG. 9 is a flowchart showing an example operation of a control device of a following vehicle according to the third embodiment.

FIG. 10 is a schematic diagram showing a notification method according to a fourth embodiment.

FIG. 11 is a flowchart showing an example operation of a control device of a following vehicle according to the fourth embodiment.

### DESCRIPTION OF THE EMBODIMENTS

The following describes embodiments in detail with reference to the accompanying drawings. Note that the following embodiments do not limit the invention according to the claims, and all combinations of features described in the embodiments are not necessarily essential for the invention. Two or more of the features described in the embodiments may also be combined. The same or similar configurations are denoted with the same reference signs, and a redundant description of which is omitted.

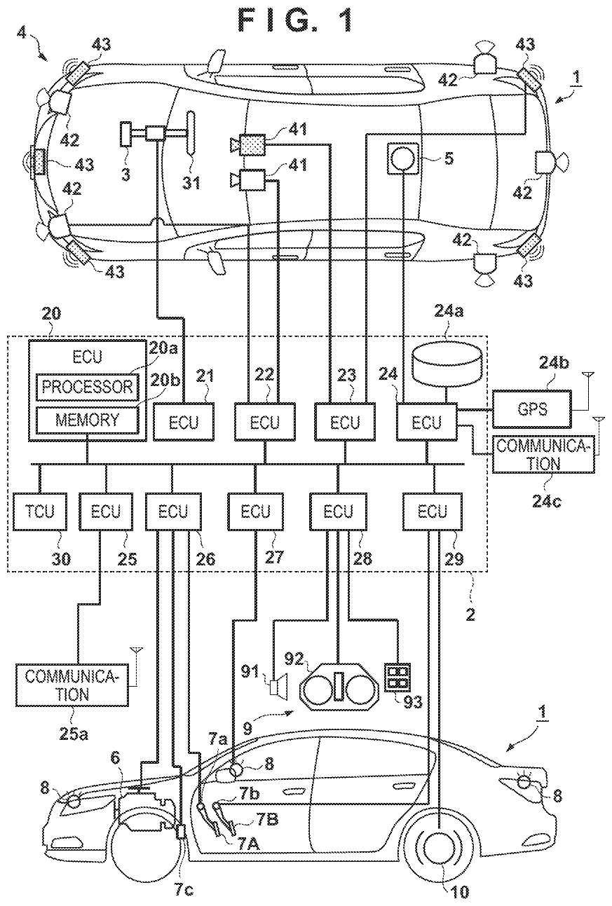

FIG. 1 is a block diagram of a vehicle 1 according to various embodiments of the present invention. FIG. 1 shows a schematic plan view and a schematic side view of the vehicle 1. An example of the vehicle 1 is a sedan-type four-wheel passenger car. The vehicle 1 may be such a four-wheel vehicle, a two-wheel vehicle, or a vehicle of another type.

The vehicle 1 includes a control device 2 for a vehicle (hereinafter simply referred to as a “control device 2”) that controls the vehicle 1. The control device 2 includes a plurality of ECUs 20 to 29 that are communicably connected to each other via an in-vehicle network. Each ECU includes a processor represented by a CPU, a memory such as a semiconductor memory, an interface with an external device, and the like. A program that is executed by the processor, data that is used by the processor for processing, and the like are stored in the memory. Each ECU may also include a plurality of processors, a plurality of memories, a plurality of interfaces, and the like. For example, the ECU 20 includes a processor 20a and a memory 20b. As a result of commands included in a program stored in the memory 20b being executed by the processor 20a, processing is executed by the ECU 20. Alternatively, the ECU 20 may also include a dedicated integrated circuit such as an ASIC for executing the processing by the ECU 20. This also applies to the other ECUs.

The following describes functions and the like of the ECUs 20 to 29. Note that the number of ECUs and functions of the ECUs can be appropriately designed, and the ECUs and the functions in the present embodiment may also be divided or integrated.

The ECU 20 executes control relating to automated driving of the vehicle 1. In the automated driving, at least one of the steering or the speed of the vehicle 1 is automatically controlled.

The ECU 21 controls an electric power steering device 3. The electric power steering device 3 includes a mechanism for steering front wheels in response to a driving operation (steering operation) made by the driver on a steering wheel 31. Also, the electric power steering device 3 includes a motor that generates a driving force for assisting the steering operation or automatically steering the front wheels, a sensor that detects a steering angle, and the like. If the vehicle 1 is in an automated driving state, the ECU 21 automatically controls the electric power steering device 3 following an instruction from the ECU 20 to control the travelling direction of the vehicle 1.

The ECUs 22 and 23 control detection units 41 to 43 for detecting conditions of a surrounding region of the vehicle and perform information processing of detection results. The detection units 41 are cameras (hereinafter may be referred to as “cameras 41”) that capture images of a region in front of the vehicle 1, and are attached to the interior side of a front window in a front region of a roof of the vehicle 1 in the present embodiment. Contours of an object and a mark line (e.g., a white line) of a lane on a road can be extracted by analyzing images captured by the cameras 41. The vehicle 1 may include a plurality of cameras 41. The plurality of cameras 41 may also be attached such that images of regions on the front side, the right side, the left side, and the rear side of the vehicle 1 can be captured.

The detection units 42 are LIDARs (Light Detection and Ranging, hereinafter may be referred to as “LIDARs 42”), and detect objects around the vehicle 1 and measure a distance to an object, for example. In the present embodiment, five LIDARs 42 are provided, two of them being respectively installed in front corner portions of the vehicle 1, one being installed in a rear center portion, and two being respectively installed in rear side portions. The detection units 43 are millimeter-wave radars (hereinafter may be referred to as “radars 43”), and detect objects around the vehicle 1 and measure a distance to an object, for example. In the present embodiment, five radars 43 are provided, one of them being installed in a front center portion of the vehicle 1, two being respectively installed in front corner portions, and two being respectively installed in rear corner portions.

The ECU 22 controls one of the cameras 41 and each LIDAR 42, and performs information processing of detection results. The ECU 23 controls the other camera 41 and each radar 43, and performs information processing of detection results. Reliability of detection results can be improved as a result of two sets of devices that detect conditions of a surrounding region of the vehicle being provided, and multifaceted analysis of a surrounding environment of the vehicle can be performed as a result of different types of detection units such as the cameras, the LIDARs, and the radars being provided.

The ECU 24 controls a gyroscope sensor 5, a GPS sensor 24b, and a communication device 24c, and performs information processing of detection results and communication results. The gyroscope sensor 5 detects a rotational movement of the vehicle 1. The course of the vehicle 1 can be determined based on a result of detection performed by the gyroscope sensor 5, a wheel speed, and the like. The GPS sensor 24b detects a current position of the vehicle 1. The communication device 24c performs wireless communication with a server that provides map information and traffic information, and acquires these types of information. The ECU 24 can access a database 24a of map information that is constructed in a memory, and finds a route from the current position to a destination, for example. The ECU 24, the map database 24a, and the GPS sensor 24b constitute what is called a navigation device.

The ECU 25 includes a communication device 25a for inter-vehicle communication. The communication device 25a performs wireless communication with another vehicle that is in a surrounding region, and exchanges information with the other vehicle. A TCU (Telematics Control Unit) 30 communicates with a network using a cellular communication line. The TCU 30 may also perform communication using Wi-Fi (registered trademark), DSRC (Dedicated Short Range Communications), or the like.

The ECU 26 controls a power plant 6. The power plant 6 is a mechanism that outputs a driving force for rotating driving wheels of the vehicle 1, and includes an engine and a transmission, for example. The ECU 26 controls output of the engine in response to a driving operation (an operation made on an accelerator or an acceleration operation) that is made by the driver and detected by an operation detection sensor 7a provided in an acceleration pedal 7A, and switches a gear range of the transmission based on information regarding a vehicle speed or the like that is detected by a vehicle speed sensor 7c, for example. If the vehicle 1 is in the automated driving state, the ECU 26 automatically controls the power plant 6 following an instruction from the ECU 20 to control acceleration and deceleration of the vehicle 1.

The ECU 27 controls lighting devices (headlights, taillights, etc.) including direction indicators 8 (blinkers). In the example shown in FIG. 1, the direction indicators 8 are provided in a front portion, door mirrors, and a rear portion of the vehicle 1.

The ECU 28 controls an input/output device 9. The input/output device 9 outputs information to the driver and accepts input of information from the driver. An audio output device 91 gives information to the driver using sound. A display device 92 gives information to the driver by displaying images. The display device 92 is arranged in a surface in front of the driver's seat, for example, and constitutes an instrument panel or the like. Note that information is given using sound and display in this example, but information may also be given using vibration or light. Also, information may also be given using a combination of two or more of sound, display, vibration, and light. Furthermore, it is also possible to vary the combination or the manner of giving information according to the level (e.g., urgency) of information to be given. An input device 93 is arranged at a position at which the input device can be operated by the driver, and is constituted by a group of switches for giving instructions to the vehicle 1, but may also include an audio input device.

The ECU 29 controls brake devices 10 and a parking brake (not shown). The brake devices 10 are disk brake devices, for example, are respectively provided on the wheels of the vehicle 1, and decelerate or stop the vehicle 1 by applying resistance to rotation of the wheels. The ECU 29 controls operations of the brake devices 10 in response to a driving operation (a brake operation) that is made by the driver and detected by an operation detection sensor 7b provided in a brake pedal 7B, for example. If the vehicle 1 is in the automated driving state, the ECU 29 automatically controls the brake devices 10 following an instruction from the ECU 20 to control deceleration and a stop of the vehicle 1. The brake devices 10 and the parking brake can also operate to maintain a stopped state of the vehicle 1. If the transmission of the power plant 6 includes a parking lock mechanism, it is also possible to cause the parking lock mechanism to operate to maintain the stopped state of the vehicle 1.

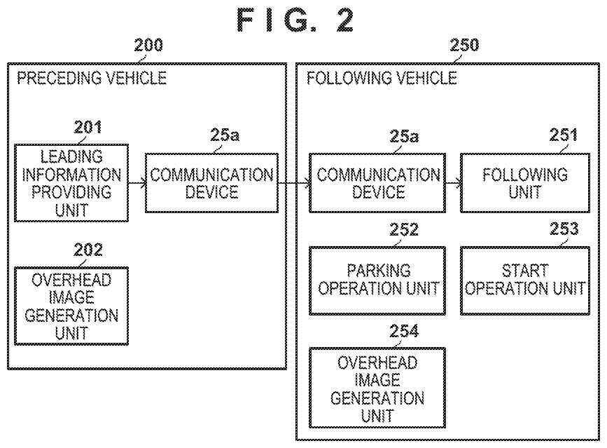

An overview of an electronically coupled travelling system will be described with reference to FIG. 2. The electronically coupled travelling system can also be called a platooning system or an electronical traction system. The electronically coupled travelling system is a system in which two or more vehicles travel in an electronically coupled state. The electronically coupled state is a state in which information that is used in travelling of a following vehicle can be provided by a preceding vehicle to the following vehicle when necessary. The electronically coupled following vehicle can automatically follow the preceding vehicle without a driving operation being made by the driver. A person may be present or absent in the driver's seat of the following vehicle. A general configuration of the electronically coupled travelling system may be similar to those in conventional technologies, and therefore the following describes an overview of the general configuration.

FIG. 2 shows examples of functional configurations of a preceding vehicle 200 and a following vehicle 250 that constitute the electronically coupled travelling system. Both the preceding vehicle 200 and the following vehicle 250 may have the same configuration as that of the vehicle 1 shown in FIG. 1. Some of the constitutional elements shown in FIG. 1 are omitted in FIG. 2.

The preceding vehicle 200 includes a leading information providing unit 201 and an overhead image generation unit 202. The leading information providing unit 201 may also be realized by the ECU 20 that executes control relating to automated driving. Alternatively (e.g., if the preceding vehicle 200 does not include an automated driving function), the leading information providing unit 201 may also be realized by another ECU in the control device 2. The overhead image generation unit 202 may also be realized by the ECU 22 that processes images captured by the cameras 41.

The leading information providing unit 201 collects information (hereinafter referred to as “travelling information”) regarding travelling of the preceding vehicle 200 such as amounts of operations made by the driver on the acceleration pedal 7A, the brake pedal 7B, and the steering wheel 31 and a vehicle speed detected by the vehicle speed sensor 7c. The leading information providing unit 201 generates information (hereinafter referred to as “leading information”) that is used by the following vehicle 250 to follow the preceding vehicle 200, based on the travelling information. The leading information providing unit 201 provides the leading information to the following vehicle 250 via the communication device 25a. Communication between the communication device 25a of the preceding vehicle 200 and the communication device 25a of the following vehicle 250 may also be performed as inter-vehicle communication. The preceding vehicle 200 may be manually driven or automatically driven while leading the following vehicle 250.

The overhead image generation unit 202 generates an overhead image of an area including the preceding vehicle 200 based on images captured by the plurality of cameras 41. Specifically, the overhead image generation unit 202 generates an overhead image by converting viewpoints of a plurality of images captured by the plurality of cameras 41 and compositing the images after the conversion.

The following vehicle 250 includes a following unit 251, a parking operation unit 252, a start operation unit 253, and an overhead image generation unit 254. The following unit 251, the parking operation unit 252, and the start operation unit 253 may also be realized by the ECU 20 that executes control relating to automated driving. Alternatively (e.g., if the following vehicle 250 does not include an automated driving function), the following unit 251 may also be realized by another ECU shown in FIG. 1 or a dedicated ECU (not shown). The overhead image generation unit 254 may also be realized by the ECU 22 that processes images captured by the cameras 41.

The following unit 251 acquires the leading information from the preceding vehicle 200 via the communication device 25a. The following unit 251 automatically controls travelling of the following vehicle 250 (specifically, driving amounts of actuators relating to driving, braking, and steering) to follow the preceding vehicle 200 based on the leading information. In the following description, an operation of controlling travelling of the following vehicle 250 such that the following vehicle 250 follows another vehicle (the preceding vehicle 200) based on information received from the other vehicle will be referred to as a “following operation”. The following unit 251 may also perform the following operation further based on a distance, a speed, an angle, or the like relative to the preceding vehicle 200, which is acquired by the detection units 41 to 43. The following vehicle 250 may also follow the preceding vehicle 200 by travelling along the same path as the preceding vehicle 200 (e.g., such that tracks of the center of the vehicle width of the preceding vehicle 200 match tracks of the center of the vehicle width of the following vehicle 250). The following unit 251 may cause the following vehicle 250 to follow the preceding vehicle 200 such that the distance between the preceding vehicle 200 and the following vehicle 250 is kept constant or the distance is varied according to the vehicle speed by, for example, making the distance short when the following vehicle 250 stops or travels at a low speed, and making the distance long when the following vehicle 250 travels at a high speed. When the vehicles are travelling, the distance between the preceding vehicle 200 and the following vehicle 250 may be a short distance (e.g., 1 m) that keeps another vehicle from entering between the preceding vehicle 200 and the following vehicle 250, and when the vehicles are stopped, the distance between the preceding vehicle 200 and the following vehicle 250 may be a shorter distance (e.g., 50 cm) that makes a pedestrian hesitate to enter between the preceding vehicle 200 and the following vehicle 250.

The parking operation unit 252 specifies a space at which the following vehicle 250 can be parked (hereinafter such a space will be referred to as a “parking space”), and performs an operation of parking the following vehicle 250 at the parking space. In the following description, an operation of controlling travelling of the following vehicle 250 to park the following vehicle 250 at a parking space will be referred to as a “parking operation”. Specifically, the parking operation unit 252 specifies a parking space by analyzing images of a surrounding region that are captured by the cameras 41. Thereafter, the parking operation unit 252 automatically controls travelling of the following vehicle 250 (specifically, driving amounts of actuators relating to driving, braking, and steering) such that the following vehicle 250 moves to the parking space.

The start operation unit 253 performs an operation of moving the following vehicle 250 from a parking space to a position outside the parking space. In the following description, an operation of controlling travelling of the following vehicle 250 to start the following vehicle 250 from a parking space will be referred to as a “starting operation”. Specifically, the start operation unit 253 specifies an environment around the parking space by analyzing images of a surrounding region that are captured by the cameras 41. Thereafter, the start operation unit 253 automatically controls travelling of the following vehicle 250 (specifically, driving amounts of the actuators relating to driving, braking, and steering) such that the following vehicle 250 moves to the outside of the parking space (e.g., a road that faces the parking space).

The overhead image generation unit 254 generates an overhead image of an area including the following vehicle 250 based on images captured by the plurality of cameras 41. Specifically, the overhead image generation unit 254 generates an overhead image by converting viewpoints of a plurality of images captured by the plurality of cameras 41 and compositing the images after the conversion.

First Embodiment

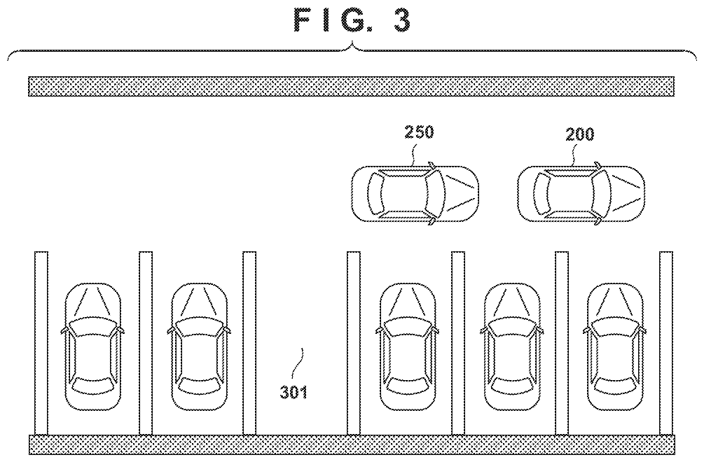

Processing that is performed when ending the following operation according to a first embodiment will be described with reference to FIG. 3. In descriptions of the first to fourth embodiments, the subject of operations of the preceding vehicle 200 may be the driver of the preceding vehicle 200 or the control device 2 of the preceding vehicle 200. Therefore, the subject of operations of the preceding vehicle 200 will not be explicitly described, and processing will be simply described as being performed by the preceding vehicle 200.

In a case where the driver is absent in the following vehicle 250 or the driver of the following vehicle 250 does not perform a driving operation (e.g., the driver is drunk or sleeping), in order that the following vehicle 250 finishes following, the preceding vehicle 200 leads the following vehicle 250 to a place where the following vehicle 250 can stop safely or the following vehicle 250 automatically moves to a place where the following vehicle 250 can stop safely after ending the following operation. However, it is difficult for the preceding vehicle 200 to lead the following vehicle 250 to a position like a parking space 301 shown in FIG. 3. Therefore, in the first embodiment, the following vehicle 250 executes the parking operation to be parked at the parking space 301 after ending the following operation of following the preceding vehicle 200. The parking operation cannot be started at every position, and accordingly, there may be a case where the following vehicle 250 cannot execute the parking operation depending on a position at which the following operation has been ended. Therefore, in the first embodiment, when the following vehicle 250 is at a position at which the parking operation can be started, the following vehicle 250 notifies the preceding vehicle 200 that leading can be finished. Upon receiving this notification, the preceding vehicle 200 can finish leading the following vehicle 250.

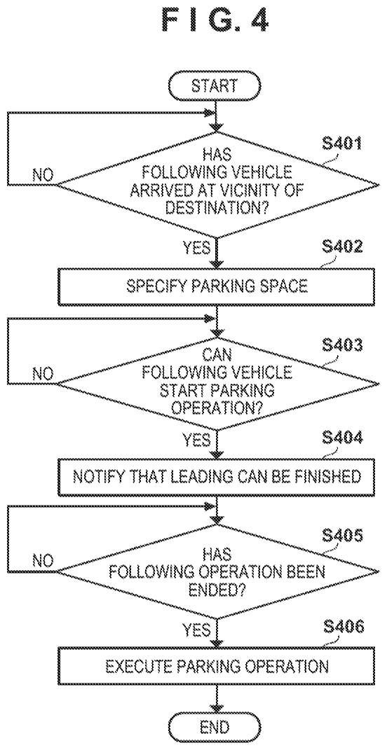

An example operation of the control device 2 of the following vehicle 250 when ending the following operation will be described with reference to FIG. 4. The example operation shown in FIG. 4 is executed by the control device 2 of the following vehicle 250. This operation may also be performed as a result of a processor (e.g., the processor 20a) of the control device 2 executing a program stored in a memory (e.g., the memory 20b). Alternatively, some or all steps of the operation shown in FIG. 4 may also be executed by a dedicated circuit. Assume that the following vehicle 250 is executing the following operation to follow the preceding vehicle 200 at the start of the operation shown in FIG. 4. That is, the control device 2 of the following vehicle 250 continuously receives leading information from the preceding vehicle 200 and controls travelling of the following vehicle 250 based on the leading information.

In step S401, the control device 2 of the following vehicle 250 (in the following description of FIG. 4, the “control device 2 of the following vehicle 250” will be simply referred to as the “control device 2”) determines whether the following vehicle 250 has arrived at the vicinity of a destination of the following operation of the following vehicle 250 (in other words, a destination of leading by the preceding vehicle 200). If the following vehicle has arrived at the vicinity of the destination (“YES” in step S401), the control device 2 proceeds to step S402, otherwise (“NO” in step S401) repeats step S401. For example, the control device 2 may compare a current position of the following vehicle 250 that is acquired by the GPS sensor 24b and the destination determined before the following operation was started (or changed during the following operation), and if the distance between the current position and the destination is no greater than a threshold value (e.g., 100 m), the control device 2 may determine that the following vehicle 250 has arrived at the vicinity of the destination. Upon approaching the destination of the following operation, the preceding vehicle 200 continues leading the following vehicle 250 while looking for a space at which the following vehicle 250 can be parked.

In step S402, the control device 2 specifies a parking space around the following vehicle 250. Assume that the following vehicle 250 is travelling in the vicinity of the parking space 301 shown in FIG. 3, for example. In this case, the control device 2 specifies the presence of the parking space 301 around the following vehicle 250 based on images of an environment around the following vehicle 250, which are captured by the cameras 41. The parking space 301 in the example shown in FIG. 3 is a section of a parking lot, but the parking space specified in this step may also be a parking space of another form, such as a section on a road in which a parking meter is installed. Assume that the preceding vehicle 200 also recognizes the parking space 301. The preceding vehicle 200 estimates a position at which the following vehicle 250 can start the parking operation and continues leading the following vehicle 250 such that the following vehicle 250 comes to this position.

In step S403, the control device 2 determines whether the following vehicle 250 is at a position at which the following vehicle 250 can start the parking operation to be parked at the parking space. If the following vehicle 250 is at a position at which the parking operation can be started (“YES” in step S403), the control device 2 proceeds to step S404, otherwise (“NO” in step S403) repeats step S403. If the following vehicle 250 is not at a position at which the following vehicle 250 can start the parking operation to be parked at the parking space, the control device 2 may also notify the preceding vehicle 200 that the parking operation cannot be started.

In step S404, the control device 2 notifies the preceding vehicle 200 that leading can be finished because the current position of the following vehicle 250 is a position at which the following vehicle 250 can start the parking operation to be parked at the parking space. This notification may also be given by transmitting a message via inter-vehicle communication. Instead of or in addition to this, this notification may also be given by flashing headlights or sounding a horn. Upon receiving this notification, the preceding vehicle 200 stops. As a result of the preceding vehicle 200 having stopped, the following vehicle 250 also stops. Upon both vehicles having stopped, the preceding vehicle 200 performs an operation for finishing leading the following vehicle 250. The control device 2 ends the following operation when leading the following vehicle 250 is finished.

In step S405, the control device 2 determines whether the following operation has been ended. If the following operation has been ended (“YES” in step S405), the control device 2 proceeds to step S406, otherwise (“NO” in step S405) repeats step S405. In step S406, the control device 2 executes the parking operation to be parked at the parking space 301, upon having ended the following operation at the position at which the following vehicle 250 can start the parking operation.

Second Embodiment

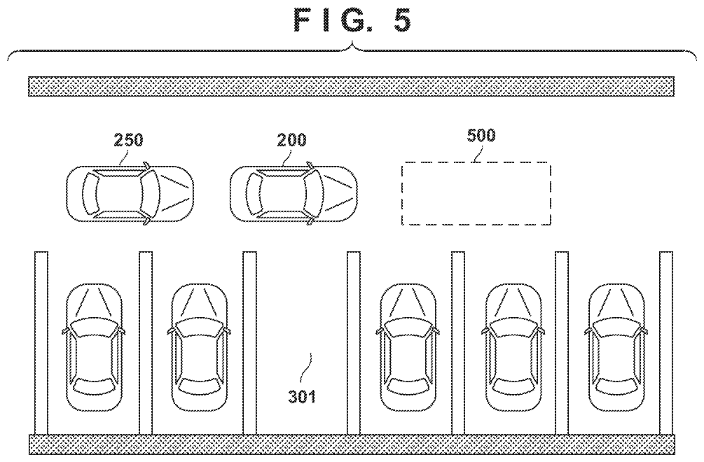

Processing that is performed when ending the following operation according to a second embodiment will be described with reference to FIG. 5. Similarly to the first embodiment, the following vehicle 250 is automatically parked at the parking space 301 after ending the following operation. In the first embodiment, the following vehicle 250 notifies the preceding vehicle 200 that leading can be finished because the following vehicle 250 is at a position at which the parking operation can be started. In the second embodiment, instead of or in addition to this, the following vehicle 250 notifies the preceding vehicle 200 of a position 500 at which the following vehicle 250 can start the parking operation. Based on this notification, the preceding vehicle 200 leads the following vehicle 250 such that the following vehicle 250 arrives at the position 500.

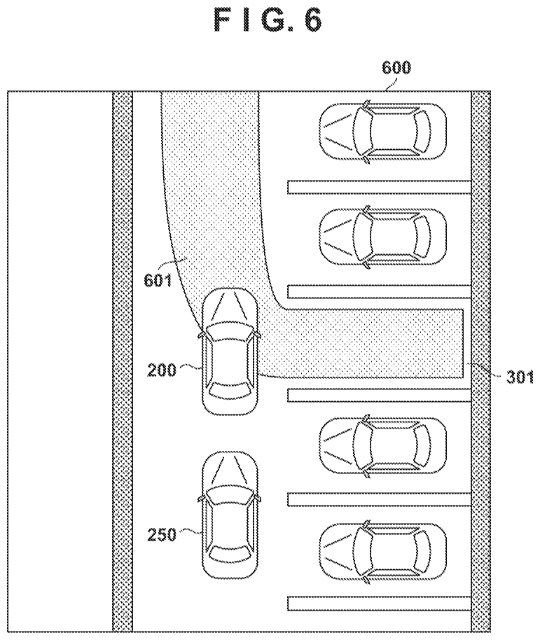

A specific example of a method for notifying the preceding vehicle 200 of the position 500 at which the following vehicle 250 can start the parking operation will be described with reference to FIG. 6. In this example, the following vehicle 250 transmits an image 600 shown in FIG. 6 to the preceding vehicle 200. The image 600 indicates positions at which the following vehicle 250 can start the parking operation. The image 600 is generated by adding the positions at which the parking operation can be started to an overhead image of an area including the following vehicle 250. In the image 600, the positions at which the parking operation can be started are indicated as an area 601 of positions at which the parking operation can be started. The image 600 is generated such that the travelling direction of the preceding vehicle 200 is upward to make it easy for the driver of the preceding vehicle 200 to grasp the image. The following vehicle 250 can generate an overhead image based on images captured by the cameras 41. In order to generate an overhead image of a wider area, the following vehicle 250 may also acquire, from the preceding vehicle 200, information regarding an environment around the preceding vehicle 200, which is captured by the cameras 41 of the preceding vehicle 200. This information may also be an overhead image of an area including the preceding vehicle 200 generated by the preceding vehicle 200. The following vehicle 250 may also generate an overhead image of an area including both the preceding vehicle 200 and the following vehicle 250 based on images captured by the plurality of cameras 41 of the following vehicle 250 and information regarding the environment around the preceding vehicle 200 obtained by the cameras 41 of the preceding vehicle 200 (e.g., by compositing an overhead image generated by the preceding vehicle 200 and an overhead image generated by the following vehicle 250). The following vehicle 250 may also provide the preceding vehicle 200 with an image that is generated by adding the positions at which the parking operation can be started to an overhead image of an area including both the preceding vehicle 200 and the following vehicle 250.

The area 601 of positions at which the parking operation can be started is a set of the plurality of positions at which the parking operation can be started. If the following vehicle 250 is included in this area 601, the following vehicle 250 can start the parking operation. The following vehicle 250 may also determine the area 601 based on the travelling direction of the following vehicle 250. Specifically, assume that the following vehicle 250 can be parked at the parking space 301 from both of the upper side and the lower side of the drawing. In the example shown in FIG. 6, the following vehicle 250 is moving from the lower side toward the upper side of the drawing, and therefore the control device 2 of the following vehicle 250 does not notify the preceding vehicle of an area on the lower side of the drawing, but notifies the preceding vehicle of an area on the upper side of the drawing.

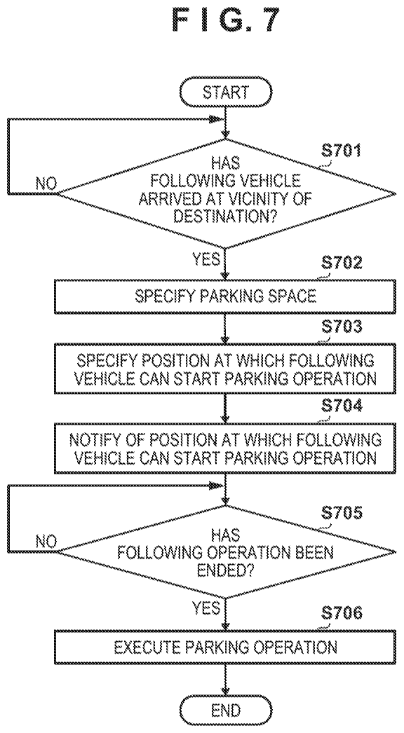

An example operation of the control device 2 of the following vehicle 250 when ending the following operation will be described with reference to FIG. 7. Similarly to the first embodiment, the example operation shown in FIG. 7 is executed by the control device 2 of the following vehicle 250. Assume that the following vehicle 250 is executing the following operation to follow the preceding vehicle 200 at the start of the operation shown in FIG. 7.

In step S701, the control device 2 of the following vehicle 250 (in the following description of FIG. 7, the “control device 2 of the following vehicle 250” will be simply referred to as the “control device 2”) determines whether the following vehicle 250 has arrived at the vicinity of a destination of the following operation of the following vehicle 250, similarly to step S401. In step S702, the control device 2 specifies a parking space around the following vehicle 250 similarly to step S402.

In step S703, the control device 2 specifies a position at which the following vehicle 250 can start the parking operation to be parked at the parking space. The control device 2 specifies a position at which the following vehicle 250 is to be located to start the parking operation to be parked at the parking space 301, by analyzing images of an environment around the following vehicle 250 captured by the plurality of cameras 41, for example. As shown in FIG. 6, the control device 2 may also specify the area 601 (a set of a plurality of positions) where the parking operation can be started. The control device 2 may also specify a position at which the parking operation can be started based on the travelling direction of the following vehicle 250 as described with reference to FIG. 6.

In step S704, the control device 2 notifies the preceding vehicle 200 of the specified position at which the parking operation can be started. This operation is performed while the following operation is executed. This notification may also be given by providing the image 600 shown in FIG. 6. Instead of or in addition to this, this notification may also be given by transmitting a message (e.g., “move 5 m forward”). Accuracy of the specified position at which the parking operation to be parked at the parking space can be started may be improved as the following vehicle 250 gets closer to the parking space 301. Therefore, the control device 2 may repeatedly execute steps S703 and S704 as the following vehicle 250 moves.

Based on the notification given in step S704, the preceding vehicle 200 leads the following vehicle 250 such that the following vehicle 250 comes to the position of the notification. When the following vehicle 250 arrives at the position of the notification, the preceding vehicle 200 stops. As a result of the preceding vehicle 200 having stopped, the following vehicle 250 also stops. Upon both vehicles having stopped, the preceding vehicle 200 performs an operation for finishing leading the following vehicle 250. The control device 2 ends the following operation when leading the following vehicle 250 is finished.

In step S705, the control device 2 determines whether the following operation has been ended. If the following operation has been ended (“YES” in step S705), the control device 2 proceeds to step S706, otherwise (“NO” in step S705) repeats step S705. In step S706, the control device 2 executes the parking operation to be parked at the parking space 301, upon having ended the following operation at the position at which the following vehicle 250 can start the parking operation.

The control device 2 may also execute the same operations as those performed in steps S403 and S404 between steps S704 and S705. Thus, the control device 2 can confirm that the following vehicle 250 has moved to the position of the notification given in step S704.

Third Embodiment

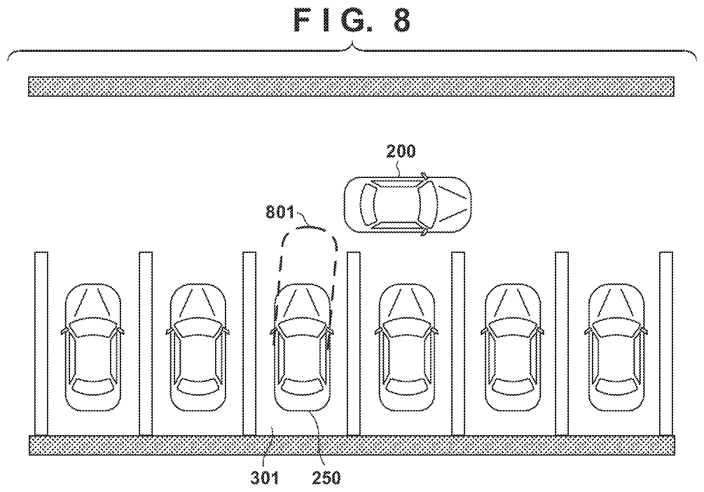

Processing that is performed when starting the following operation according to a third embodiment will be described with reference to FIG. 8. In the following description, not only a vehicle that is operating as the preceding vehicle 200 (i.e., a vehicle that is actually leading), but also a vehicle that is going to operate as the preceding vehicle 200 will be referred to as the “preceding vehicle 200”. Also, not only a vehicle that is operating as the following vehicle 250 (i.e., a vehicle that is actually following), but also a vehicle that is going to operate as the following vehicle 250 will be referred to as the “following vehicle 250”.

In a case where the driver is absent in the following vehicle 250 or the driver of the following vehicle 250 does not perform a driving operation (e.g., the driver is drunk or sleeping), in order that the following vehicle 250 starts the following operation, the preceding vehicle 200 moves to a position at which the preceding vehicle 200 can lead the following vehicle 250 or the following vehicle 250 automatically moves to the rear side of the preceding vehicle 200. However, if the following vehicle 250 stops at a position like the parking space 301 shown in FIG. 8, it is difficult for the preceding vehicle 200 to move to a position at which the preceding vehicle 200 can lead the following vehicle 250. Therefore, in the third embodiment, the following vehicle 250 executes the starting operation to move to the rear side of the preceding vehicle 200 that is waiting. It is not possible to move to every position by executing the starting operation. Also, depending on the position at which the preceding vehicle 200 is waiting, there is a risk of the following vehicle 250 being unable to travel along the same path as the preceding vehicle 200 or the following vehicle 250 colliding with another vehicle as a result of travelling along the same path as the preceding vehicle 200. For example, assume that the preceding vehicle 200 is waiting at the position shown in FIG. 8. Also, assume that the following vehicle 250 has moved to the position indicated by a dashed line 801 by executing the starting operation. However, the following vehicle 250 cannot travel along the same path as the preceding vehicle 200 because an angle formed between the travelling direction of the preceding vehicle 200 and the travelling direction of the following vehicle 250 is large. Therefore, in the third embodiment, if the preceding vehicle 200 is located at a position that allows the following vehicle 250 to move to the rear side of the preceding vehicle 200, the following vehicle 250 notifies the preceding vehicle 200 that the following vehicle 250 can move. Upon receiving this notification, the preceding vehicle 200 can wait for the following vehicle 250 to move to the rear side of the preceding vehicle 200.

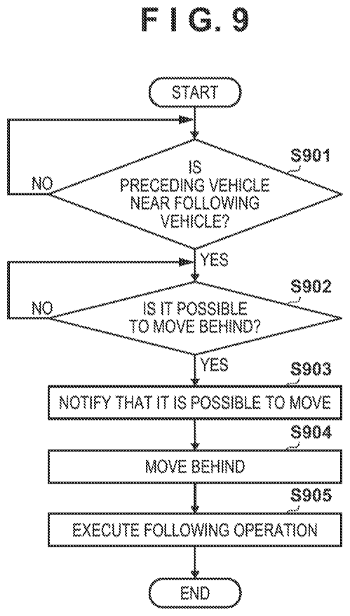

An example operation of the control device 2 of the following vehicle 250 when starting the following operation will be described with reference to FIG. 9. The example operation shown in FIG. 9 is executed by the control device 2 of the following vehicle 250. This operation may also be performed as a result of a processor (e.g., the processor 20a) of the control device 2 executing a program stored in a memory (e.g., the memory 20b). Alternatively, some or all steps of the operation shown in FIG. 9 may also be executed by a dedicated circuit. Assume that the following vehicle 250 has stopped at the parking space 301 at the start of the operation shown in FIG. 9. Accordingly, the following vehicle 250 is not executing the starting operation and the following operation. The preceding vehicle 200 approaches the following vehicle 250 to start to lead the following vehicle 250. A geographical position of the following vehicle 250 and appearance features of the following vehicle 250 are provided to the preceding vehicle 200, and the preceding vehicle 200 finds the following vehicle 250 based on this information.

In step S901, the control device 2 of the following vehicle 250 (in the following description of FIG. 9, the “control device 2 of the following vehicle 250” will be simply referred to as the “control device 2”) determines whether the preceding vehicle 200 is near the following vehicle 250. If the preceding vehicle 200 is near the following vehicle 250 (“YES” in step S901), the control device 2 proceeds to step S902, otherwise (“NO” in step S901) repeats step S901. For example, if inter-vehicle communication can be performed with the preceding vehicle 200, the control device 2 may determine that the preceding vehicle 200 is near the following vehicle 250. Alternatively, the control device 2 may compare a current position of the following vehicle 250 acquired by the GPS sensor 24b and a current position of the preceding vehicle 200 acquired via inter-vehicle communication, and if the distance between the current positions is no greater than a threshold value (e.g., 10 m), the control device 2 may determine that the preceding vehicle 200 is near the following vehicle 250.

In step S902, the control device 2 determines whether it is possible to move from the parking space 301 to a position behind the preceding vehicle 200 by executing the starting operation. If it is possible to move to a position behind the preceding vehicle 200 (“YES” in step S902), the control device 2 proceeds to step S903, otherwise (“NO” in step S902) repeats step S902. If it is not possible to move from the parking space 301 to a position behind the preceding vehicle 200, the control device 2 may also notify the preceding vehicle 200 that the starting operation cannot be started. The preceding vehicle 200 estimates a position that allows the following vehicle 250 to start the starting operation, and moves to the estimated position.

In step S903, the control device 2 notifies the preceding vehicle 200 that it is possible to move from the parking space 301 to a position behind the preceding vehicle 200 by executing the starting operation. This notification may also be given by transmitting a message via inter-vehicle communication. Instead of or in addition to this, this notification may also be given by flashing headlights or sounding a horn. Upon receiving this notification, the preceding vehicle 200 stops and waits until the following vehicle 250 moves to the position behind the preceding vehicle 200.

In step S904, the control device 2 executes the starting operation to move to the position behind the preceding vehicle 200 and stops at this position. In step S905, the control device 2 starts to execute the following operation.

Fourth Embodiment

Processing that is performed when starting the following operation according to a fourth embodiment will be described. Similarly to the third embodiment, the following vehicle 250 automatically starts from the parking space 301 to start the following operation. In the third embodiment, the following vehicle 250 notifies the preceding vehicle 200 that the following vehicle 250 can move to a position behind the preceding vehicle 200. In the fourth embodiment, instead of or in addition to this, the following vehicle 250 notifies the preceding vehicle 200 of a position to which the following vehicle 250 can move by executing the starting operation. The preceding vehicle 200 waits for the following vehicle 250 in front of the position of the notification.

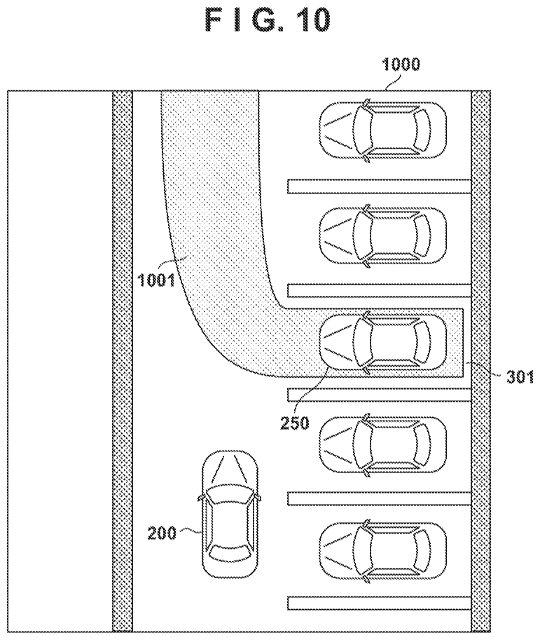

A specific example of a method for notifying the preceding vehicle 200 of the position to which the following vehicle can move by executing the starting operation will be described with reference to FIG. 10. In this example, the following vehicle 250 transmits an image 1000 shown in FIG. 10 to the preceding vehicle 200. The image 1000 indicates positions to which the following vehicle 250 can move by executing the starting operation. The image 1000 is generated by adding the positions to which the following vehicle can move by executing the starting operation to an overhead image of an area including the following vehicle 250. In the image 1000, the positions to which the following vehicle can move by executing the starting operation are indicated as an area 1001 of positions to which the following vehicle can move by executing the starting operation. The image 1000 is generated such that the travelling direction of the preceding vehicle 200 is upward to make it easy for the driver of the preceding vehicle 200 to grasp the image. The following vehicle 250 can generate an overhead image based on images captured by the cameras 41. In order to generate an overhead image of a wider area, the following vehicle 250 may also acquire, from the preceding vehicle 200, information regarding an environment around the preceding vehicle 200, which is captured by the cameras 41 of the preceding vehicle 200. This information may also be an overhead image of an area including the preceding vehicle 200 generated by the preceding vehicle 200. The following vehicle 250 may also generate an overhead image of an area including both the preceding vehicle 200 and the following vehicle 250 based on images captured by the plurality of cameras 41 of the following vehicle 250 and information regarding the environment around the preceding vehicle 200 obtained by the cameras 41 of the preceding vehicle 200 (e.g., by compositing an overhead image generated by the preceding vehicle 200 and an overhead image generated by the following vehicle 250). The following vehicle 250 may also provide the preceding vehicle 200 with an image that is generated by adding the positions to which the following vehicle can move by executing the starting operation to an overhead image of an area including both the preceding vehicle 200 and the following vehicle 250.

The area 1001 of positions to which the following vehicle can move by executing the starting operation is a set of the plurality of positions to which the following vehicle can move by executing the starting operation. The following vehicle 250 may also determine the area 1001 based on the travelling direction of the preceding vehicle 200. Specifically, assume that the following vehicle 250 can start from the parking space 301 toward both of the upper side and the lower side of the drawing. In the example shown in FIG. 10, the preceding vehicle 200 is moving from the lower side toward the upper side of the drawing, and therefore the control device 2 of the following vehicle 250 does not notify the preceding vehicle of an area on the lower side of the drawing, but notifies the preceding vehicle of an area on the upper side of the drawing.

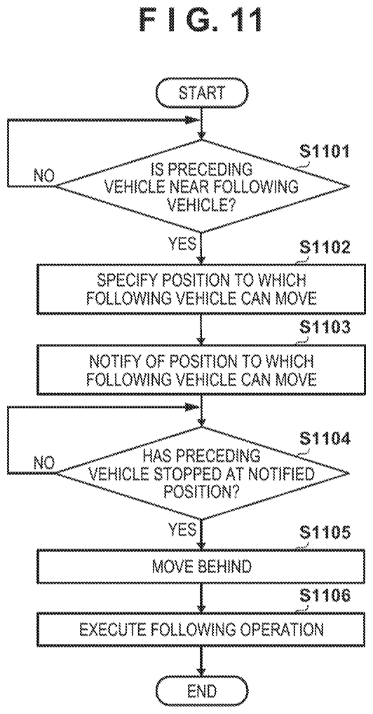

An example operation of the control device 2 of the following vehicle 250 when starting the following operation will be described with reference to FIG. 11. Similarly to the third embodiment, the operation example shown in FIG. 11 is executed by the control device 2 of the following vehicle 250. Assume that the following vehicle 250 has stopped at the parking space 301 at the start of the operation shown in FIG. 11.

In step S1101, the control device 2 of the following vehicle 250 (in the following description of FIG. 11, the “control device 2 of the following vehicle 250” will be simply referred to as the “control device 2”) determines whether the preceding vehicle 200 is near the following vehicle 250, similarly to step S901.

In step S1102, the control device 2 specifies a position to which the following vehicle 250 can move by executing the starting operation. The control device 2 specifies a position to which the following vehicle 250 can move from the parking space 301 by executing the starting operation, by analyzing images of an environment around the following vehicle 250 captured by the plurality of cameras 41, for example. As shown in FIG. 10, the control device 2 may also specify the area 1001 (a set of a plurality of positions) to which the following vehicle can move by executing the starting operation. The control device 2 may also specify a position to which the following vehicle can move by executing the starting operation, based on the travelling direction of the preceding vehicle 200 as described with reference to FIG. 10.

In step S1103, the control device 2 notifies the preceding vehicle 200 of the specified position to which the following vehicle can move by executing the starting operation. This notification may also be given by providing the image 1000 shown in FIG. 10. Instead of or in addition to this, this notification may also be given by transmitting a message (e.g., “move 10 m forward”). Based on the notification given in step S1103, the preceding vehicle 200 moves to and stops at a position in front of the position of the notification.

In step S1104, the control device 2 determines whether the preceding vehicle 200 has stopped in front of the position of the notification. If the preceding vehicle 200 has stopped in front of the position of the notification (“YES” in step S1104), the control device 2 proceeds to step S1105, otherwise (“NO” in step S1104) repeats step S1104.

In step S1105, the control device 2 executes the starting operation to move to a position behind the preceding vehicle 200, and stops at this position. In step S1106, the control device 2 starts to execute the following operation.

Summary of Embodiments

Item 1

A control device (2) of a vehicle (1, 250), the device including:

a travel control unit (251, 252) capable of executing a following operation of controlling travelling of the vehicle such that the vehicle follows another vehicle (200) based on information received from the other vehicle and a parking operation of controlling travelling of the vehicle to park the vehicle at a parking space (301);

a determination unit (252) configured to determine whether the vehicle is at a position (500, 601) at which the parking operation can be started; and

a notification unit (252) configured to notify the other vehicle that leading can be finished, in a case where it is determined that the vehicle is at a position at which the parking operation can be started while the travel control unit is executing the following operation.

According to this configuration, transition from the following operation to the parking operation can be smoothly performed. Therefore, the driver of the following vehicle need not perform a driving operation for this transition.

Item 2

The control device according to Item 1, wherein, when the vehicle has arrived at the vicinity of a destination to which the vehicle travels following the other vehicle, the determination unit determines whether the vehicle is at a position at which the parking operation can be started.

According to this configuration, it is possible to suppress situations where determinations are unnecessarily made.

Item 3

A control device (2) of a vehicle (1, 250), the device including:

a travel control unit (251, 252) capable of executing a following operation of controlling travelling of the vehicle such that the vehicle follows another vehicle (200) based on information received from the other vehicle and a parking operation of controlling travelling of the vehicle to park the vehicle at a parking space (301);

a specifying unit (252) configured to specify a position (500, 601) at which the vehicle can start the parking operation; and

a notification unit (252) configured to notify the other vehicle of the position specified by the specifying unit while the travel control unit is executing the following operation.

According to this configuration, transition from the following operation to the parking operation can be smoothly performed. Therefore, the driver of the following vehicle need not perform a driving operation for this transition.

Item 4

The control device according to Item 3, wherein the notification unit provides the other vehicle with an image (600) that indicates the position at which the parking operation can be started.

According to this configuration, the position of the notification can be intuitively grasped.

Item 5

The control device according to Item 4,

wherein the vehicle includes a plurality of cameras (41),

the control device further includes an image generation unit that generates an overhead image of an area including the vehicle based on images captured by the plurality of cameras, and

the notification unit provides the other vehicle with an image that is generated by adding the position at which the vehicle can start the parking operation to the overhead image.

According to this configuration, the position of the notification can be more intuitively grasped.

Item 6

The control device according to Item 5, wherein the image generation unit acquires information regarding an environment around the other vehicle from the other vehicle, and generates the overhead image based on the images captured by the plurality of cameras and the information regarding the environment around the other vehicle such that the overhead image further includes the other vehicle.

According to this configuration, an image of a wider area can be generated.

Item 7

The control device according to any one of Items 3 to 6, wherein, in a case where a plurality of positions are specified by the specifying unit, the notification unit notifies the other vehicle of the plurality of positions.

According to this configuration, a position to which the vehicle moves can be selected from a plurality of candidates.

Item 8

The control device according to any one of Items 3 to 7, wherein, when the vehicle has arrived at the vicinity of a destination to which the vehicle travels following the other vehicle, the specifying unit specifies the position at which the vehicle can start the parking operation.

According to this configuration, it is possible to suppress situations where determinations are unnecessarily made.

Item 9

The control device according to any one of Items 1 to 8, wherein the travel control unit starts the parking operation when the vehicle has ended the following operation at a position at which the parking operation can be started.

This configuration eliminates a need for a driving operation performed by the driver.

Item 10

A control device (2) of a vehicle (1, 250), the device including:

a travel control unit (251, 253) capable of executing a following operation of controlling travelling of the vehicle such that the vehicle follows another vehicle (200) based on information received from the other vehicle and a starting operation of controlling travelling of the vehicle to start the vehicle from a parking space (301);

a determination unit (253) configured to determine whether it is possible to move from the parking space to a position behind the other vehicle by executing the starting operation; and

a notification unit (253) configured to notify the other vehicle that it is possible to move, in a case where it is determined that it is possible to move to the position behind the other vehicle.

According to this configuration, transition from the starting operation to the following operation can be smoothly performed. Therefore, the driver of the following vehicle need not perform a driving operation for this transition.

Item 11

A control device (2) of a vehicle (1, 250), the device including:

a travel control unit (251, 253) capable of executing a following operation of controlling travelling of the vehicle such that the vehicle follows another vehicle (200) based on information received from the other vehicle and a starting operation of controlling travelling of the vehicle to start the vehicle from a parking space (301);

a specifying unit (253) configured to specify a position (1001) at which the vehicle can end the starting operation; and

a notification unit (253) configured to notify the other vehicle of the position specified by the specifying unit.

According to this configuration, transition from the starting operation to the following operation can be smoothly performed. Therefore, the driver of the following vehicle need not perform a driving operation for this transition.

Item 12

The control device according to Item 11, wherein the notification unit provides the other vehicle with an image (1000) that indicates a position to which the vehicle can move by executing the starting operation.

According to this configuration, the position of the notification can be intuitively grasped.

Item 13

The control device according to Item 12,

wherein the vehicle includes a plurality of cameras (41),

the control device further includes an image generation unit that generates an overhead image of an area including the vehicle based on images captured by the plurality of cameras, and

the notification unit provides the other vehicle with an image that is generated by adding the position (1001) to which the vehicle can move by executing the starting operation to the overhead image.

According to this configuration, the position of the notification can be more intuitively grasped.

Item 14

The control device according to Item 13, wherein the image generation unit acquires information regarding an environment around the other vehicle from the other vehicle, and generates the overhead image based on the images captured by the plurality of cameras and the information regarding the environment around the other vehicle such that the overhead image further includes the other vehicle.

According to this configuration, an image of a wider area can be generated.

Item 15

The control device according to any one of Items 10 to 14, wherein the travel control unit starts the starting operation when the other vehicle has stopped in front of a position to which the vehicle can move.

This configuration eliminates a need for a driving operation performed by the driver.

Item 16

A vehicle (1, 250) including the control device (2) according to any one of Items 1 to 15.

According to this configuration, a vehicle that realizes the above-described effects is provided.

The invention is not limited to the embodiments described above, and various variations and changes can be made within the gist of the invention.

What is claimed is:

1. A control device of a vehicle, the device comprising:
a memory for storing computer readable code; and
a processor operatively coupled to the memory, the processor configured to:
execute a following operation of controlling travelling of the vehicle such that the vehicle follows another vehicle based on information received from the other vehicle and a parking operation of controlling travelling of the vehicle to park the vehicle at a parking space;
determine whether the vehicle is at a position at which the parking operation can be started; and
notify the other vehicle that leading can be finished, in a case where it is determined that the vehicle is at a position at which the parking operation can be started while the processor is executing the following operation.

2. The control device according to claim 1,
wherein, when the vehicle has arrived at the vicinity of a destination to which the vehicle travels following the other vehicle, the processor determines whether the vehicle is at a position at which the parking operation can be started.

3. The control device according to claim 1,
wherein the processor starts the parking operation when the vehicle has ended the following operation at a position at which the parking operation can be started.

4. A vehicle comprising the control device according to claim 1.

5. A control device of a vehicle, the device comprising:
a memory for storing computer readable code; and
a processor operatively coupled to the memory, the processor configured to:
execute a following operation of controlling travelling of the vehicle such that the vehicle follows another vehicle based on information received from the other vehicle and a parking operation of controlling travelling of the vehicle to park the vehicle at a parking space;
specify a position at which the vehicle can start the parking operation; and
notify the other vehicle of the position specified by the processor while the processor is executing the following operation.

6. The control device according to claim 5,
wherein the processor provides the other vehicle with an image that indicates the position at which the parking operation can be started.

7. The control device according to claim 6,
wherein the vehicle includes a plurality of cameras,
the processor generates an overhead image of an area including the vehicle based on images captured by the plurality of cameras, and
the processor provides the other vehicle with an image that is generated by adding the position at which the vehicle can start the parking operation to the overhead image.

8. The control device according to claim 7,
wherein the processor acquires information regarding an environment around the other vehicle from the other vehicle, and generates the overhead image based on the images captured by the plurality of cameras and the information regarding the environment around the other vehicle such that the overhead image further includes the other vehicle.

9. The control device according to claim 5,
wherein, in a case where a plurality of positions are specified, the processor notifies the other vehicle of the plurality of positions.

10. The control device according to claim 5,
wherein, when the vehicle has arrived at the vicinity of a destination to which the vehicle travels following the other vehicle, the processor specifies the position at which the vehicle can start the parking operation.

11. The control device according to claim 5,
wherein the processor starts the parking operation when the vehicle has ended the following operation at the position at which the parking operation can be started.

12. A vehicle comprising the control device according to claim 5.

13. A control device of a vehicle, the device comprising:
a memory for storing computer readable code; and
a processor operatively coupled to the memory, the processor configured to:
execute a following operation of controlling travelling of the vehicle such that the vehicle follows another vehicle based on information received from the other vehicle and a starting operation of controlling travelling of the vehicle to start the vehicle from a parking space;
determine whether it is possible to move from the parking space to a position behind the other vehicle by executing the starting operation; and
notify the other vehicle that it is possible to move, in a case where it is determined that it is possible move to the position behind the other vehicle.

14. The control device according to claim 13,
wherein the processor starts the starting operation when the other vehicle has stopped in front of a position to which the vehicle can move.

15. A vehicle comprising the control device according to claim 13.

16. A control device of a vehicle, the device comprising:
a memory for storing computer readable code; and
a processor operatively coupled to the memory, the processor configured to:
execute a following operation of controlling travelling of the vehicle such that the vehicle follows another vehicle based on information received from the other vehicle and a starting operation of controlling travelling of the vehicle to start the vehicle from a parking space;
specify a position at which the vehicle can end the starting operation; and
notify the other vehicle of the position specified by the processor.

17. The control device according to claim 16,
wherein the processor provides the other vehicle with an image that indicates a position to which the vehicle can move by executing the starting operation.

18. The control device according to claim 17,
wherein the vehicle includes a plurality of cameras,
the processor generates an overhead image of an area including the vehicle based on images captured by the plurality of cameras, and
the processor provides the other vehicle with an image that is generated by adding the position to which the vehicle can move by executing the starting operation to the overhead image.

19. The control device according to claim 18,
wherein the processor acquires information regarding an environment around the other vehicle from the other vehicle, and generates the overhead image based on the images captured by the plurality of cameras and the information regarding the environment around the other vehicle such that the overhead image further includes the other vehicle.

20. The control device according to claim 16,
wherein the processor starts the starting operation when the other vehicle has stopped in front of a position to which the vehicle can move.
